(19) United States
(12) Patent Application Publication
(10) Pub. No.: US 2018/0093832 A1
(43) Pub. Date: Apr. 5, 2018

(54) Transporting Device With Tubular Flexible Body

(71) Applicant: MOVE IT EASY APS, Struer (DK)

(72) Inventor: Vagn Sindersen, Vinderup (DK)

(73) Assignee: MOVE IT EASY APS, Struer (DK)

(21) Appl. No.: 15/820,598

(22) Filed: Nov. 22, 2017

Related U.S. Application Data
(63) Continuation of application No. PCT/DK2016/050145, filed on May 25, 2016.

(30) Foreign Application Priority Data
May 26, 2015 (DK) PA 2015 00307

(51) Int. Cl. B65G 17/12; B65G 17/32

(52) U.S. Cl. CPC B65G 17/12; B65G 2201/0211; B65G 17/323

(57) ABSTRACT

A transporting device for conveying items over a conveying route includes a tubular flexible body having an interior space. The transporting device includes a first end portion and a second end portion, wherein either a gap is provided between the end portions, or wherein it is possible to provide a gap between the end portions by moving the end portions away from each other. The transporting device includes at least one wing member attached to the body in such a manner that displacement of the at least one wing member causes the end portions to be moved away from each other whereby the gap is increased. The interior space is arranged and configured to contain the items being conveyed when using the transporting device. Thus, items can be inserted into and removed from the interior space when a gap is provided between the end portions.

This application is a Continuation of, and claims priority under 35 U.S.C. § 120 to, International Application No. PCT/DK2016/050145, filed 25 May 2016, and claims priority therethrough under 35 U.S.C. § § 119, 365, to Danish App. No. PA 2015 00307, filed 26 May 2015, the entireties of which are incorporated by reference herein.

### BACKGROUND

### Field of Endeavor

The present invention relates to a transporting device for conveying items, including items that require a fixed, predefined orientation, over a conveying route.

### Brief Description of the Related Art

When small-sized items or components are handled or used in a construction process, it is often necessary to keep the items in a specific predefined orientation in order to facilitate a subsequent assembling process or packaging. Therefore, a manual handling step is often required. Manual handling is costly and introduces the risk of human errors; it would therefore be desirable to be able to provide an alternative way of transporting such items.

It is known to apply a tubular transporting device that applies corresponding opening and closing structures enabling insertion of items to the transporting device and removal of items from the transport device. Such tubular transport device comprises an internal canal surrounded by side structures arranged in a manner in which the canal is configured for storage and transport of items.

The known transporting devices are, however, difficult to use in processes that require flexible access to the items. It is typically only possible to establish access to the internal space of the transporting device at specific insertion and removal stations.

U.S. Patent App. Publ. No. 2007/074955A1 discloses a transporting device for conveying goods over a conveying route. The transporting device comprises a transporting belt and a rope-like traction element for exerting a traction force upon the transporting belt. The transporting device is not capable of keeping the items in a specific, predefined orientation in order to facilitate a subsequent assembling process or packaging.

Accordingly, it would be desirable to provide an improved transporting device capable of establishing access to the interior space of the transport device in a more flexible manner not limited to specific insertion and removal stations.

### SUMMARY

Numerous aspects of the instant disclosure are explained in the following description and illustrated in the accompanying drawings.

One aspect includes a transporting device capable of keeping the items in a specific, predefined orientation.

Another aspect includes a transporting device capable of conveying items in a flexible way around a predefined pattern.

It is also an aspect to provide a transporting device capable of receiving items from relative position (e.g., above the transporting device) and delivering items in another relative position (e.g., under the transporting device).

One transporting device described herein is a transporting device for conveying items over a conveying route, wherein the transporting device comprises a tubular flexible body having an interior space, wherein the transporting device comprises a first end portion and a second end portion, wherein either a gap is provided between the end portions, or it is possible to provide a gap between the end portions by moving the end portions from each other, characterized in that the transporting device comprises at least one wing member attached to the body in such a manner that displacement of the at least one wing member causes the end portions to be moved away from each other whereby the gap is increased, wherein the interior space is arranged and configured to contain the items being conveyed when using the transporting device, wherein items can be inserted into and removed from the interior space when a gap is provided between the end portions.

Hereby, it is possible to provide a transporting device capable of keeping the items in a specific, predefined orientation. It is furthermore possible to provide a transporting device capable of achieving access to the interior space of the transportation device and of conveying items in a flexible way around a predefined pattern.

The transportation device is configured to convey items that are required to be maintained in a predefined orientation. By positioning the items in the interior space surrounded by the body, it is possible to fix the orientation of the items during transportation.

The transportation device comprises a tubular body having an interior space.

Hereby, it is possible to twist and turn the transportation device and at the same time keep the orientation of the items fixed.

The transporting device comprises a first end portion and a second end portion, wherein either a gap is provided between the end portions or it is possible to provide a gap between the end portions by moving the end portions away from each other. Accordingly, it is possible to insert items into the interior space or to remove items from the interior space through the gap.

The transporting device comprises at least one wing member attached to the body in such a manner that displacement of the at least one wing member causes the end portions to be moved away from each other whereby the gap is increased. Hereby, it is possible to establish an opening (gap), through which there is access to the interior space. It is possible to establish automatic, displacement arrangements that engage the at least one wing member which is displaced in such a manner that the gap is increased.

It may be an advantage that the at least one wing member extends radially in extension of the body.

The transporting device makes it possible to maintain the orientation of the items and at the same time provide flexible transportation of the items.

The transporting device preferably comprises an opening arrangement configured to be brought into an open configuration and into a closed configuration by means of the at least one wing member.

The transporting device makes it possible to transport items with a constant speed e.g. along a predefined, closed circuit.

It may be an advantage that the body is flexible and elastic in such a manner that the transporting device can be exposed to twisting and bending without introducing a risk for the items to fall out of the interior space.

The interior space is arranged and configured to contain the items being conveyed when using the transporting device, wherein items can be inserted into and removed from the interior space when a gap is provided between the end portions.

It may be an advantage that the transporting device comprises a tubular body provided with a longitudinal gap or a tubular body, in which it is possible to provide a gap between the end portions by moving the end portions away from each other.

Hereby, it is possible to apply the transporting device along its entire length and establish a gap at any position along the entire length of the transporting device.

The size of the gap may be varied or controlled by mechanically affecting the at least one wing member.

It may be an advantage that the transporting device comprises a body comprising a first side structure and a second side structure attached thereto, wherein the two side structures surround the interior space and constitute a structure having a C-shaped or O-shaped cross section.

Hereby, it is possible to achieve a transporting device suitable for receiving and transporting items of different dimensions, shapes and types.

It may be advantageous that the transporting device comprises a body comprising a first side structure and a second side structure attached thereto, wherein the sides structures are of equal size and are arranged symmetrically.

It may be beneficial that a first wing member and a second wing member protrude from the area, in which the first side structure and the second side structure are joined.

Hereby, it is possible to displace the two wing members towards each other and thereby increase the size of the gap or establish a gap (in case the end portions abut each other).

It may be an advantage that the wing members are symmetrically arranged.

It may be advantageous that an attachment member is provided in the distal end of each wing member.

Hereby, it is possible to apply the attachment members for fixation and transport of the transporting device.

The attachment members may have different cross-sectional shapes, including a circular, a polygonal (e.g. a hexagonal or an octagonal) cross section.

It may be beneficial that a connection member provided with an attachment member in its distal end protrudes from the area, in which the first side structure and the second side structure are joined.

Hereby, it is possible to apply the connection member and the attachment member to fixate and transport (drive) the transporting device.

It may be advantageous that the end portions abut each other.

Hereby, the transporting device is, by default, closed and thus suitable for transporting granulates or feed.

It may be advantageous that the transporting device has a constant cross section.

Hereby, the manufacturing process can be simplified, and it is possible to manufacture the transporting device by extrusion.

When the transporting device has a constant cross-section (and thus a constant cross-sectional area), it is possible to drive the transporting device by means of rotatably mounted wheels which are brought into engagement with portions of the periphery of the transporting device.

It may be beneficial that the transporting device is transparent or comprises transparent structures.

Hereby, it is possible to carry out a visual inspection. Likewise, it would be possible to apply visual detection e.g. automatic, vision-based handling of items.

It may be beneficial that the transporting device comprises a cavity extending along the inner side of the body along the area in which the first side structure and the second side structure are joined.

Hereby, the cavity ensures that the displacement of the wing members towards the connection member causes the end portions to be moved away from each other in such a manner that the gap becomes larger.

The transport system according to the invention is a transport system comprising a transporting device according invention and one or more driving structures.

Hereby, the driving structures can be applied to drive the transporting device.

It may be an advantage that one driving structure is a motor.

The motor may be an electric motor.

It may be advantageous that the driving structure is an engagement structure formed as a rotatably mounted wheel. Hereby, an easy-producible and robust construction can be provided.

It may be beneficial that a rotatably mounted wheel is mechanically connected to the transporting device and to the motor.

Hereby, the power of the motor can be transferred to the transporting device in an easy manner.

It may be advantageous that the transport system comprises structures for displacing the at least one wing member at one or more predefined positions.

Hereby, the structures for displacing the at least one wing member can be used to provide access to the interior space in order to insert items into the interior space or to remove items from the interior space.

### BRIEF DESCRIPTION OF THE DRAWINGS

The invention will become more fully understood from the detailed description given herein below. The accompanying drawings are given by way of illustration only, and thus, they are not limitative of the present invention. In the accompanying drawings:

FIG. 1A shows a schematic side view of a transporting device according to an embodiment of the invention arranged in a driving arrangement;

FIG. 1B shows a schematic view of another transporting device according to an embodiment of the invention;

FIG. 1C shows a schematic illustration of a transporting device according to an embodiment of the invention arranged in a driving arrangement;

FIG. 1D shows a schematic view of another transporting device according to an embodiment of the invention;

FIG. 2A shows a schematic view of a transporting device according to an embodiment of the invention;

FIG. 2B shows a schematic illustration of the transporting device shown in FIG. 2A arranged in a driving arrangement;

FIG. 2C shows a schematic illustration of a closed transporting device according to an embodiment of the invention;

FIG. 3A shows a schematic view of a transporting device according to an embodiment of the invention in a configuration in which the transporting device surrounds an item and is conveying the item;

FIG. 3B shows a schematic view of a transporting device shown in FIG. 3A in a configuration in which the transporting device is open in order to facilitate removal of the item;

FIG. 3C shows a schematic perspective view of the transporting device shown in FIG. 3A and in FIG. 3B;

FIG. 4A shows a schematic view of a first transporting device according to an embodiment of the invention;

FIG. 4B shows a schematic view of a second transporting device according to an embodiment of the invention;

FIG. 4C shows a schematic view of a third transporting device according to an embodiment of the invention;

FIG. 4D shows a schematic view of a fourth transporting device according to an embodiment of the invention;

FIG. 5A shows a schematic view of a transporting device according to an embodiment of the invention;

FIG. 5B shows a schematic side view of the transporting device shown in FIG. 5A;

FIG. 5C shows a schematic perspective view of the transporting device shown in FIG. 5A and in FIG. 5B;

FIG. 6 shows a schematic perspective view of a transporting system according to an embodiment of the invention;

FIG. 7A shows a schematic front view of a transporting device according to an embodiment of the invention in a closed configuration;

FIG. 7B shows the transporting device shown in FIG. 7A in an open configuration;

FIG. 7C shows a schematic front view of a transporting device according to an embodiment of the invention in a closed configuration;

FIG. 7D shows the transporting device shown in FIG. 7C in an open configuration;

FIG. 7E shows a schematic front view of a transporting device according to an embodiment of the invention in an open configuration;

FIG. 7F shows the transporting device shown in FIG. 7E in a closed configuration transporting an apple;

FIG. 7G shows the transporting device shown in FIG. 7F in an open configuration delivering the apple to a receiving station;

FIG. 8A shows a side view of three segments of a transporting device according to an embodiment of the invention;

FIG. 8B shows a perspective view of a segment of a transporting device according to an embodiment of the invention;

FIG. 8C shows a perspective view of the segment shown in FIG. 8B, wherein additional receiving structures have been mounted to attachment structures of the transporting device;

FIG. 8D shows a perspective view of a segment of a transporting device according to an embodiment of the invention; and

FIG. 8E shows a perspective view of another segment of a transporting device according to an embodiment of the invention.

### DETAILED DESCRIPTION OF EXEMPLARY EMBODIMENTS

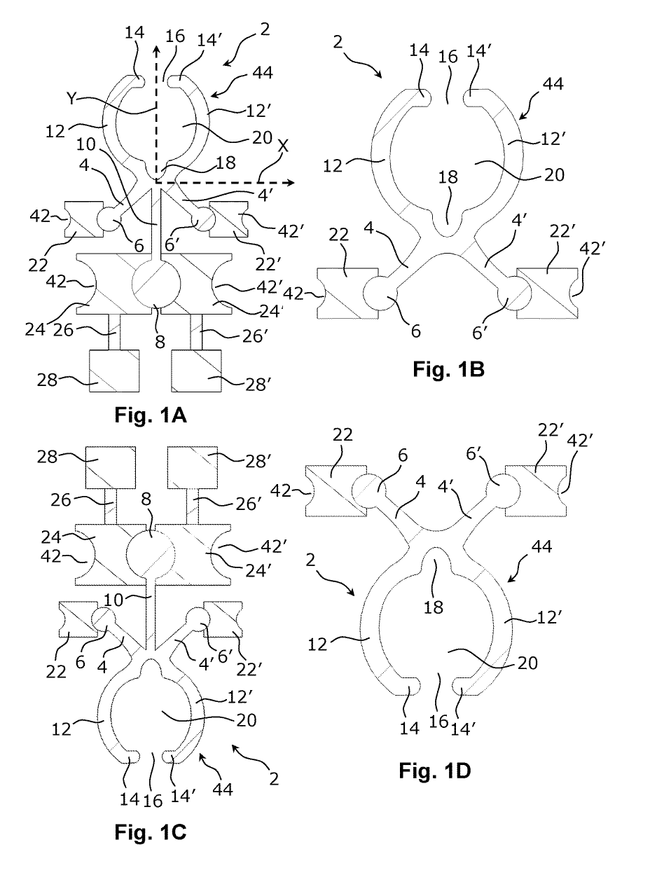

Referring now in detail to the drawings for the purpose of illustrating preferred embodiments of the present invention, a transporting device 2 of the present invention is illustrated in FIG. 1A.

FIG. 1A illustrates a schematic cross-sectional view of a transporting system 2 according to an embodiment of the invention arranged in a driving arrangement. The transporting system 2 includes a body 44 including a first side structure 12 and a second side structure 12′ attached thereto. The two side structures 12, 12′ constitute a C-shaped profile.

An end portion 14 is provided in the free end of the first side structure 12. The end portion 14 is directed towards an opposing end portion 14′ provided in the free end of the other side structure 12′. A gap 16, through which access to the interior space 20 surrounded by the side structures 12, 12′ can be achieved, is provided between the two end portions 14, 14′.

The end portions 14, 14′ are rounded and extend parallel to the transversal axis X (along the width of the transporting device) and perpendicular to the vertical axis Y (along the height) of the transporting device 2.

A thin, plate-shaped connection member 10 extends parallel to the vertical axis Y, in extension of the area in which the first side structure 12 and the second side structure 12′ are joined. An attachment member 8 having a circular cross section is provided in the free end of the connection member 10.

A first wing member 4 and another wing member 4′ extend on each side of the proximal end of the connection member 10. An attachment member 6, 6′ having a circular cross section is provided in each end of the wings 4, 4′. A first rotatably mounted wheel 22 and a second rotatably mounted wheel 22′ (the rotation arrangement is not shown) are provided. The two wheels 22, 22′ abut the first attachment member 6 and the second attachment member 6′, respectively. Every wheel 22, 22′ is provided with an engagement structure 42, 42′ shaped as a cavity configured to engage the attachment members 6, 6′.

By rotation of the wheels 22, 22′, it is possible to drive the transporting device 2 in the desired direction with a desired speed. It is possible to drive the wheels 22, 22′ by electrical motors (not shown) that are directly or indirectly connected to a driving shaft (not shown) connected to the wheels 22, 22′.

Furthermore, the two wheels 22, 22′ are displaceably mounted and thus configured to be displaced along the transversal axis X in order to displace the wing members 4, 4′ towards the connection member 10. By displacing the wing members 4, 4′ towards the connection member 10, it is possible to move the end portions 14, 14′ away from each other and hereby increase the size of the gap 16 in order to be able to insert items into the space 20 or to remove items from the space 20. The cavity 18 ensures that the displacement of the wing members 4, 4′ towards the connection member 10 causes the end portions 14, 14′ to be moved away from each other in such a manner that the size of the gap 16 is increased.

An attachment member 8 engaging a first driving wheel 24 and another driving wheel 24′ is provided in the distal end of the connection member 10. The two wheels are provided with engagement structures 42, 42′ shaped as cavities and configured to engage the attachment member 8. Accordingly, the wheels 24, 24′ are capable of driving the transporting device 2 in the desired direction with a desired speed. Each of the wheels 24, 24′ are attached to a shaft 26, 26′ each connected to a motor 28, 28′.

FIG. 1B illustrates a schematic cross-sectional view of another transporting device 2 according to the invention. The transporting device shown in FIG. 1B differs from the transporting device shown in FIG. 1A by not being provided with a connection member 10 and an attachment member 8 attached thereto.

The transporting device 2 includes a body 44 including a first side structure 12 and a second side structure 12′ attached thereto, wherein the two side structures 12, 12′ constitute a structure having a C-shaped profile.

A first end portion 14 and an opposing end portion 14′ are provided in the distal end of the first side structure 12 and in the second side structure 12′. A gap 16 is provided between the two end portions 14, 14′. It is possible to have access to the interior space 20 surrounded by the side structures 12, 12′ through the gap 16.

A first wing member 4 and a second wing member 4′, respectively, protrude from the area, in which the first side structure 12 and the second side structure 12 are attached to each other. An attachment member 6, 6′ having a circular cross section is provided in the distal end of each wing member 4, 4′.

A first rotatably mounted wheel 22 and a second rotatably mounted wheel 22′ abut the first attachment member 8 and the second attachment member 6′, respectively. The two wheels 22, 22′ are provided with cavity-shaped engagement structures 42, 42′ configured to engage the attachment members 6, 6′.

Rotation of the wheels 22, 22′ drives the transporting device 2. It is possible to drive the wheels 22, 22′ by using e.g. electrical motors (not shown) that are directly or indirectly connected to a shaft (not shown) connected to the wheels 22, 22′.

Even though it is not shown, the two wheels 22, 22′ are slideably attached and thus capable of being displaced along the transversal axis (along the width) in order to move the wing members 4, 4′ towards each other and the end portions 14, 14′ away from each other in such a manner that the gap 16 is increased in order to allow for insertion of an item into the interior space 20 or in order to remove an item from the interior space 20. The cavity 18 ensures that the displacement of the wing members towards the connection member 10 causes the end portions 14, 14′ to be moved away from each other in such a manner that the gap 16 becomes larger.

FIG. 1C illustrates a schematic cross-sectional view of a transporting device 2 according to an embodiment of the invention arranged in a driving arrangement. The transporting device 2 shown in FIG. 1C corresponds to the transporting device 2 shown in FIG. 1A. However both the transporting device 2 and the driving arrangement have been turned upside down (rotated 180 degrees with respect to horizontal).

FIG. 1D illustrates a schematic view of another transporting device 2 according to an embodiment of the invention arranged in a driving arrangement. The transporting device 2 shown in FIG. 1D corresponds to the transporting device 2 shown in FIG. 1A. However both the transporting device 2 and the driving arrangement have been turned upside down (rotated 180 degrees with respect to horizontal).

It is possible to manufacture the transporting device 2 in a flexible (bendable) material such as rubber, EPDM (ethylene propylene diene monomer) or other materials having the desired mechanical properties (large elasticity).

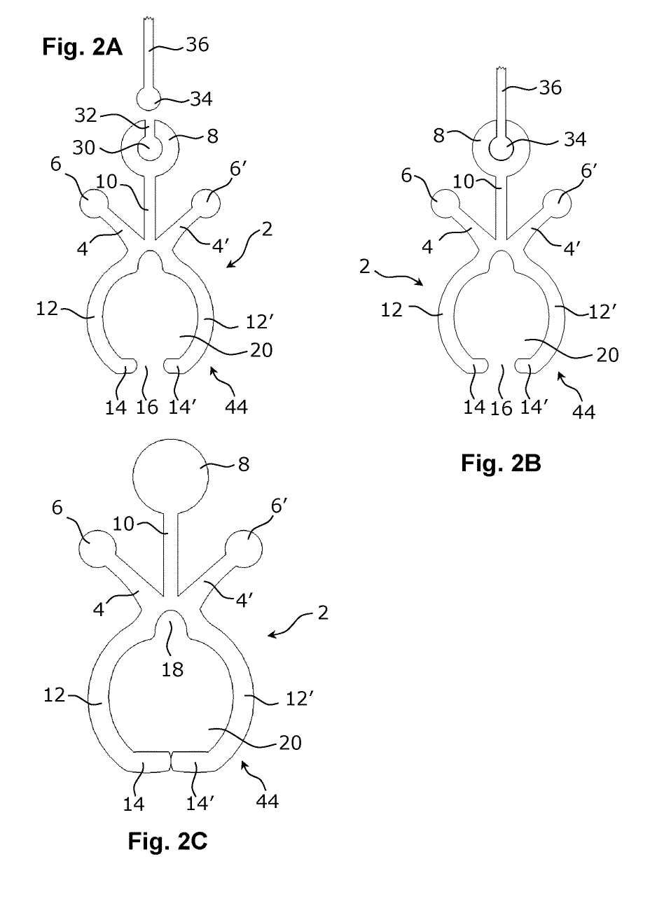

FIG. 2A illustrates a schematic end view of a transporting device 2 according to an embodiment of the invention. The transporting device 2 includes a body 44 including a first side structure 12 and a second side structure 12′ attached thereto. The two side structures 12, 12′ constitute a C-shaped profile.

In the free end of the first side structure 12 and of the second side structure 12′, a first end portion 14 and a second opposing end portion 14′ are provided. A gap 16, through which there is access to the interior space 20 surrounded by the side structures 12, 12′, is provided between the first end portion 14 and the second end portion 14′.

A first wing member 4 and a second wing member 4′ are arranged in extension of the area in which the first side structure 12 and the second side structure 12′ are attached to each other. In the distal end of each wing member 4, 4′, an attachment member 6, 6′ having a circular cross section is provided.

Even though no rotatably mounted wheel is shown, it is possible to provide a suitable driving arrangement e.g. corresponding to the one shown in FIG. 1A, FIG. 1B, FIG. 1C or FIG. 1D.

A thin, plate-shaped connection member 10 extends parallel to the vertical axis of the transporting device 2 in extension of the area at which the first side structure 12 and the second side structure 12′ are joined. An attachment structure having a circular cross section is provided in the free end of the connection member 10. A canal 30 having a circular cross section is provided in the attachment member 8. A gap 32 having a rectangular cross section is provided in extension of the canal 30.

A driving arrangement including an attachment structure 34 provided in the free end of a connection structure 36 having a rectangular cross section is provided above the attachment member 8.

As it can be seen in FIG. 2B, the attachment structure 34 is configured to be inserted into the canal 30 and the gap 32 is configured to receive the connection member structure 36. Accordingly, the transporting device 2 can be driven by a driving arrangement including the attachment structure 34 and the connection structure 36.

FIG. 2C illustrates a schematic illustration of a closed transporting device 2 according to an embodiment of the invention. The transporting device 2 includes a body 44 having a first side structure 12 and a second side structure 12′ attached to the first side structure 12, wherein the two side structures 12, 12′ constitute an O-shaped profile. A first end portion 14 is provided in the free end of the first side structure 12, whereas a second, opposite end portion 14′ is provided in the free end of the second side structure 12′. The end portions 14, 14′ abut each other. By moving the portions 14, 14′ away from each other, it is possible to provide a gap, through which there is access to the interior space 20 that is surrounded by the side structures 12, 12′.

The transporting device 2 is suitable for transport of granulate, powder, small cables or other items required to be transported in a closed space (compartment).

A first wing member 4 and a second wing member 4′ are provided in extension of the area in which the first side structure 12 and the second side structure 12′, respectively, are joined. An attachment member 6, 6′ having a circular cross section is provided in the distal end of each of the wing member 4, 4′.

Even though it is not shown in FIG. 2C, it is possible to provide a driving arrangement for driving the transporting device 2. It is possible to provide a driving arrangement like the one shown in FIG. 1A, FIG. 1B, FIG. 1C or FIG. 1D, by way of example.

A thin, plate-shaped connection member 10 is provided in extension of the area in which the first side structure 12 and the second side structure 12′ are attached to each other. The connection member 10 extends upwardly, parallel to the vertical axis of the transporting device 2. An attachment member 10 having a circular cross section is provided in the free end of the attachment member 8. A cavity 18 is provided. The cavity 18 ensures that displacement of the wing members 4, 4′ towards the connection member 10 causes the end portions 14, 14′ to be displaced away from each other in such a manner that a gap is provided between the end portions 14, 14′.

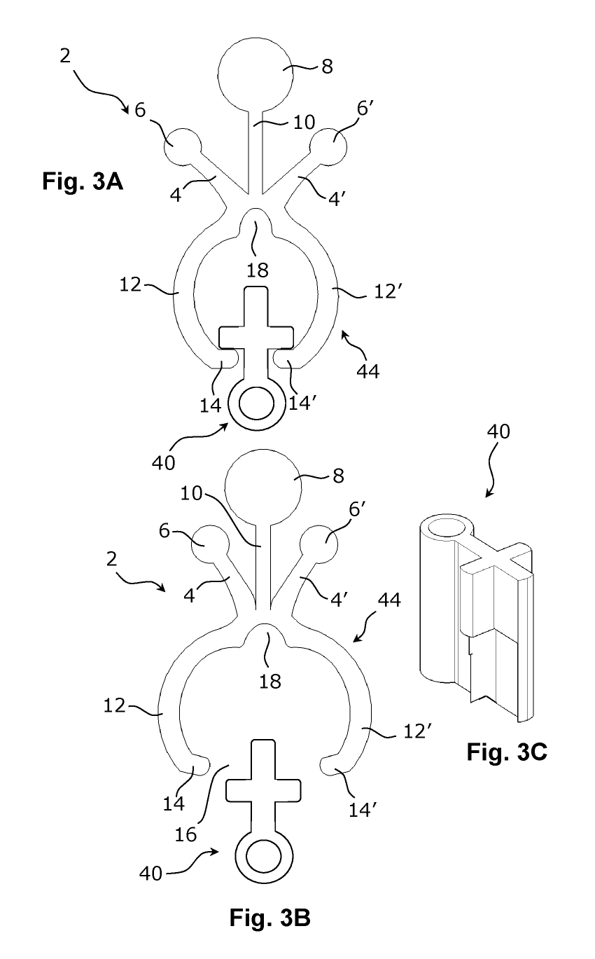

FIG. 3A illustrates a schematic end view of a transporting device 2 according to an embodiment of the invention in a configuration in which the transporting device 2 surrounds an item 40 and is conveying the item 40. The transporting device 2 has a body 44 including a first side structure 12 and a second side structure 12′. The two side structures 12, 12′ are attached to each other and constitute a structure having a C-shaped profile.

A first end portion 14 and a second, opposite end portion 14′ arranged in a distance from the first end portion 14 are provided in the free end of the first side structure 12 and in the free end of the second side structure 12′. The body 44 includes an interior space 20 surrounded by the side structures 12, 12′.

A first wing member 4 and a second wing member 4′ are provided in extension of the area in which the first side structure 12 and the second side structure 12′ are joined. An attachment member 6, 6′ having a circular cross section is provided in the distal end of each wing member 4, 4′.

A connection member 10 extends in extension of the area in which the first side structure 12 and the second side structure 12′ are attached to each other. The connection member 10 extends upwardly, parallel to the vertical axis of the transporting device 2. An attachment member is provided in the free end of the connection member 10.

A cavity 18 is provided to ensure that displacement of the wing members 4, 4′ towards the connection member 10 causes the end portions 14, 14′ to be moved away from each other in such a manner that a gap is established between the end portions 14, 14′.

FIG. 3B illustrates a schematic view of a transporting device 2 shown in FIG. 3A in a configuration in which the transporting device 2 is open in order to facilitate removal of the item 40 from the transporting device 2.

It can be seen that the two wing members 4, 4′ are displaced towards each other compared to the configuration shown in FIG. 3A. Accordingly, a gap 16 has been provided between the end portions 14, 14′ in such a manner that the item 40 can be removed from the transporting device 2.

FIG. 3C illustrates a schematic perspective view of the transporting device 2 shown in FIG. 3A and in FIG. 3B. It can be seen that the item 40 is not symmetric. By applying the transporting device 2, it is possible to provide directional orientated transportation of the item 40 in such a manner that the orientation of the item 40 is maintained during transportation.

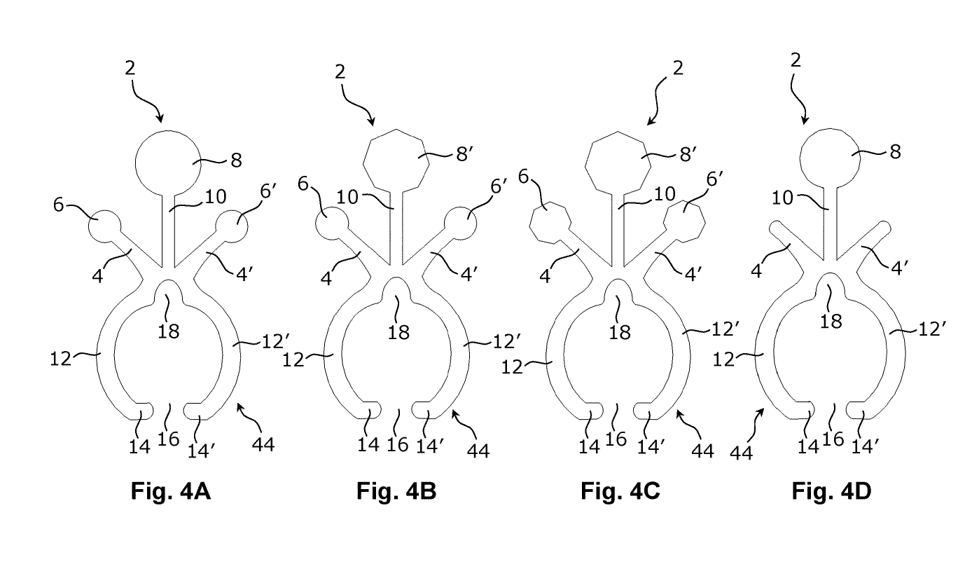

FIG. 4A illustrates a schematic view of a first transporting device 2 according to an embodiment of the invention. The transporting device 2 corresponds to the one shown in FIG. 3A. The transporting device 2 includes a body 44 equipped with a first side structure 12 and a second side structure 12′ attached thereto, wherein the two side structures constitute a structure having a C-profile.

In the free end of the first side structure 12, a first end portion 14 is provided. The first end portion 14 is directed towards an opposite, second end portion 14′ arranged in the free end of the second side structure 12′. A gap 16 is provided between the two end portions 14, 14′. Through the gap 16, it is possible to achieve access to the interior space surrounded by the side structures 12, 12′.

The end portions 14, 14′ are rounded and extend parallel to the width of the transporting device 2 and perpendicular to the height of the transporting device 2. A thin, plate-shaped connection member 10 is provided in extension of the area in which the first side structure 12 and the second side structure 12′ are connected to each other. The thin, plate-shaped connection member 10 extends parallel to the height of the transporting device 2. An attachment member 8 is provided in the free end of the connection member 10. The attachment member 8 has a circular cross section.

On each side of the proximal portion of the connection member 10, a first wing member 4 and a second wing member 4′ extend, respectively. An attachment member 6, 6′ having a circular cross section is provided in the distal end of each wing member 4, 4′.

By moving the wing members 4, 4′ towards the connection member 10, it is possible to displace the end portions 14, 14′ away from each other in such a manner that the gap 16 is increased. Accordingly, it is possible to insert an item into the space 20 or to remove an item from the space 20. The cavity 18 ensures that displacement of the wing members 4, 4′ towards the connection member 10 causes the end portions 14, 14′ to be moved away from each other, whereby the gap 16 is increased.

An attachment member 8 configured to be brought into engagement with a driving arrangement, e.g. of the kind shown in FIGS. 1A and 1n FIG. 1C, is provided in the free end of the connection member 10.

FIG. 4B illustrates a schematic view of a second transporting device 2 according to an embodiment of the invention. The transporting device 2 corresponds to the one shown in FIG. 4A except from the attachment member 8′ provided in the free end of the connection member 10. The attachment member 8′ has a hexagonal cross section.

FIG. 4C illustrates a schematic view of a third transporting device 2 according to an embodiment of the invention. The transporting device 2 corresponds to the one shown in FIG. 4A except from the attachment member 8′ (having a hexagonal cross section) provided in the free end of the connection member 10 and the two attachment members 6, 6′ having a hexagonal cross section.

FIG. 4D illustrates a schematic view of a fourth transporting device 2 according to an embodiment of the invention. The transporting device 2 corresponds to the one shown in FIG. 4A except that no attachment members are attached to the two wing members 4, 4′.

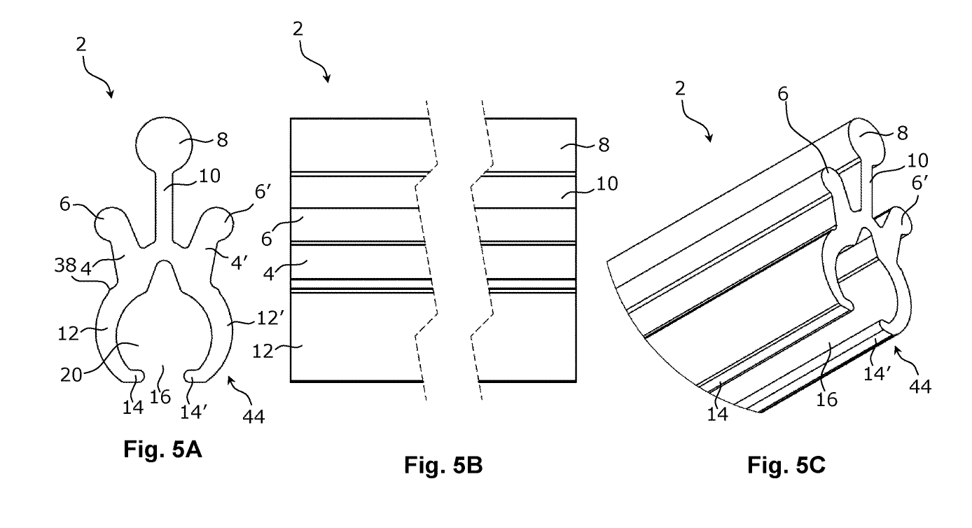

FIG. 5A illustrates a schematic view of a transporting device 2 according to an embodiment of the invention. The transporting device 2 includes a body 44 consisting of a first side structure 12 and a second side structure 12′ attached thereto, wherein the two side structures 12, 12′ constitute a structure having a basically C-shaped profile.

A first end portion 14 is provided in the free end of the first side structure. The first end portion 14 faces an opposite, second end portion 14′ provided in the free end of the second side structure 12′. A gap 16 is provided between the two end portions 14, 14′. It is possible to get access to the interior space surrounded by the side structures 12, 12′ through the gap 16.

The end portions 14, 14′ are rounded and extend parallel to the width of the transporting device 2 and perpendicular to the height of the transporting device 2.

A thin, plate-shaped connection member 10 is provided in extension of the area in which the first side structure 12 and the second side structure 12′ are attached to each other. The plate-shaped connection member 10 extends parallel to the height of the transporting device 2. An attachment member 8 having a circular cross section is provided in the free end of the connection member 10.

A first wing member 4 and a second wing member 4′ extend at each side of the proximal portion of the connection member 10. An attachment member 6, 6′ having a circular cross section is provided in each end of each wing member 4, 4′.

It is possible to displace the end portions away from each other by pressing the wing members 4, 4′ towards the connection member 10. Hereby, the gap 16 is increased in such a manner that an item can be inserted into the space 20 or removed from the space 20. The cavity 18 facilitates that displacement of the wing members 4, 4′ towards the connection member 10 causes that the end portions 14, 14′ are moved away from each other in such a manner that the gap 16 is increased.

An attachment member 8 configured to be brought into contact with a driving arrangement (e.g. of the type illustrated in FIG. 1A or in FIG. 1C) is provided in the free end of the connection member 10.

FIG. 5B illustrates a schematic side view of the transporting device 2 shown in FIG. 5A, and FIG. 5C illustrates a schematic perspective view of the transporting device 2 shown in FIG. 5A and in FIG. 5B. The transporting device 2 may be provided a one long contiguous (a one-piece body) structure that can be conveyed somehow like a conveyor belt.

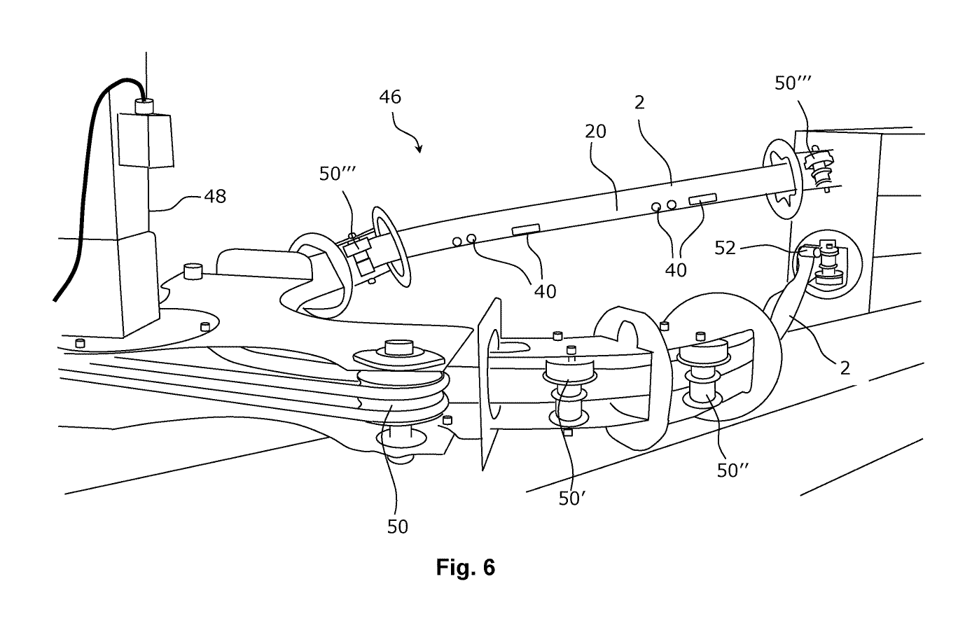

FIG. 6 illustrates a schematic perspective view of a transporting system 46 according to an embodiment of the invention. The transporting system 46 includes a driving structure having engagement structure 50 formed as a rotatably mounted wheel 50 and a motor 48 being mechanically connected to the wheel 50. The transporting system 46 further includes additional rotatably mounted wheels 50′, 50″, 50′″ arranged and configured to assist the motion of the transporting device 2 of the transporting system 46. The transporting device 2 corresponds to the one explained with reference to FIG. 5 A, FIG. 5B and FIG. 5C.

The transporting system 46 is used to transportation of small-sized items 40 arranged in the interior space 20 of the transporting device 2.

It can be seen, that the transporting device 2 is twisted 180 degrees from one side to another of the transporting system 46. The idler 52 arranged above the transporting device 2 supports the twisting action and keeps the transporting device 2 in place. The transporting system 46 is capable of receiving items 40 from relative position (e.g. above the transporting device 2) and delivering items 40 in another relative position (e.g. under the transporting device 2). Moreover, it can be seen that the transporting device 2 can be moved around corners and along structures while the transporting device 2 is being twisted.

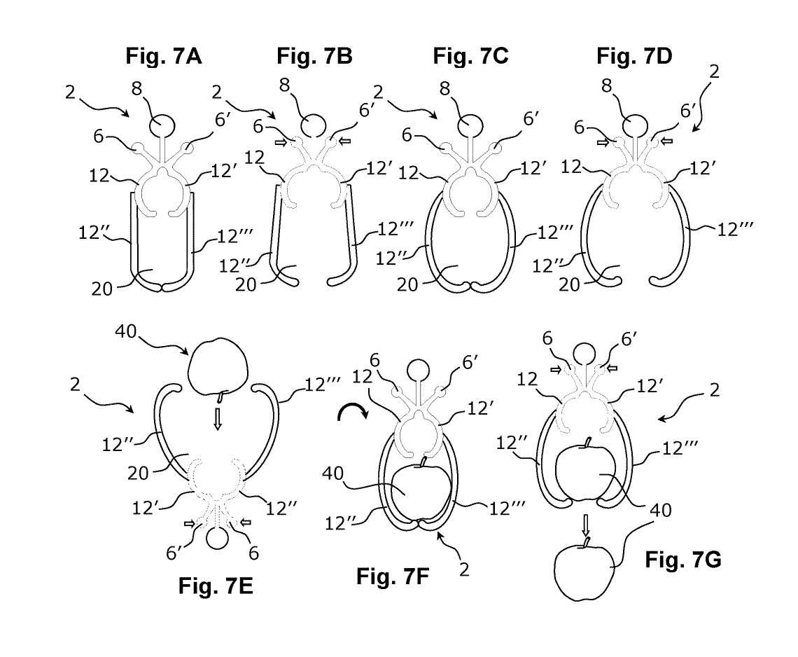

FIG. 7A illustrates a schematic front view of a transporting device 2 according to an embodiment of the invention in a closed configuration. FIG. 7B illustrates the transporting device 2 shown in FIG. 7A in an open configuration. FIG. 7C illustrates a schematic front view of a transporting device 2 according to an embodiment of the invention in a closed configuration and FIG. 7D illustrates the transporting device 2 shown in FIG. 7C in an open configuration.

The transporting device 2 includes a body consisting of a first side structure 12 and a second side structure 12′ attached thereto, wherein the two side structures 12, 12′ constitute a structure having a basically C-shaped profile.

A thin, plate-shaped connection member is provided in extension of the area in which the first side structure 12 and the second side structure 12′ are attached to each other. The plate-shaped connection member extends parallel to the height of the transporting device 2 and an attachment member 8 having a circular cross section is provided in the free end of the connection member 10.

A first wing member and a second wing member extend at each side of the proximal portion of the connection member. An attachment member 6, 6′ having a circular cross section is provided in each end of each wing member.

It is possible to displace the end portions away from each other by pressing the wing members towards the connection member. Hereby, the gap is increased in such a manner that an item can be inserted into the space 20 or removed from the space 20. An attachment member 8 configured to be brought into contact with a driving arrangement (e.g. of the type illustrated in FIG. 1A or in FIG. 1C) is provided in the free end of the connection member 10.

FIG. 7E illustrates a schematic front view of a transporting device 2 according to an embodiment of the invention in an open configuration.

FIG. 7F illustrates the transporting device 2 shown in FIG. 7E in a closed configuration transporting an apple 40 and FIG. 7G illustrates the transporting device 2 shown in FIG. 7F in an open configuration delivering the apple 40 to a receiving station (not shown).

The transporting device 2 corresponds to the one shown in FIG. 7C and in FIG. 7D. It can be seen that the gap can be increased to such an extent that an apple 40 can be inserted into the space 20. Accordingly, it is possible to transport the apple 40 in a manner In which the apple is restricted from being bruised. The transporting device 2 is turned upside down from FIG. 7D to FIG. 7E. Accordingly, the transporting device 2 is capable of receiving items 40 from relative position (e.g. above the transporting device) and delivering items 40 in another relative position (e.g. under the transporting device).

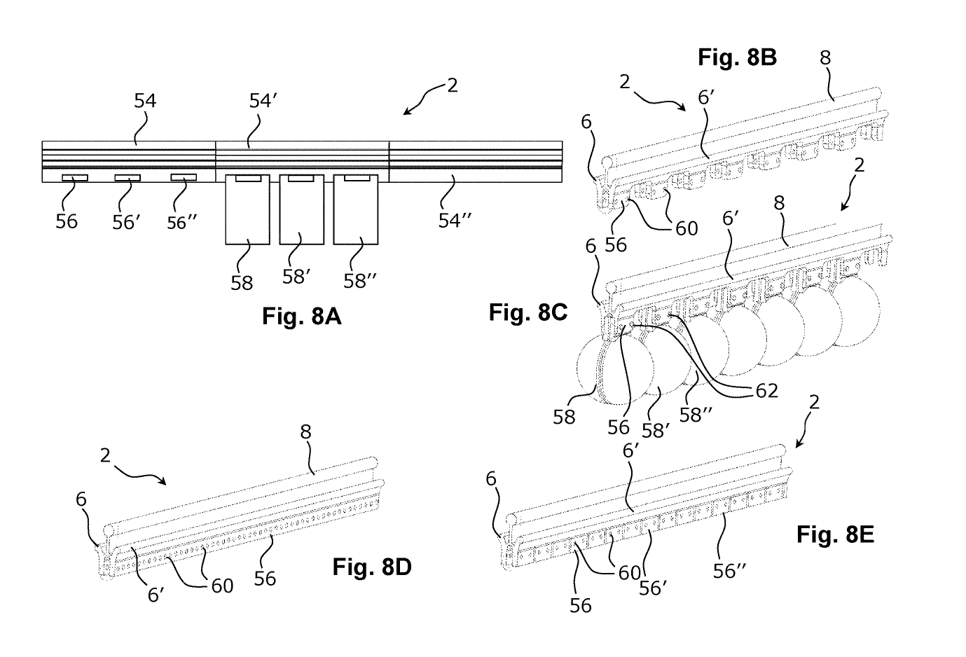

FIG. 8A illustrates a side view of three segments 54, 54′, 54″ of a transporting device 2 according to an embodiment of the invention. The first segment 54 is attached to the second segment 54′, which is attached to the third segment 54″. Three attachment structures 56, 56′, 56″ are attached and evenly distributed along the length of the first segment 54. The attachment structures 56, 56′, 56″ are considered to receive receiving structures 58, 58′, 58″ like the ones 58, 58′, 58″ attached to the second segment 54′.

FIG. 8B illustrates a perspective view of a segment of a transporting device 2 according to an embodiment of the invention. The transporting device 2 includes a centrally arranged attachment member 8 configured to receive engagement members (e.g. driving wheels) for driving the transporting device 2. The transporting device 2 moreover includes wing members each provided with an attachment member 6, 6′. The transporting device 2 furthermore includes a plurality of attachment structure 56 provided with holes 60 for fixation of receiving structures (58 see FIG. 8C).

FIG. 8C illustrates a perspective view of the segment shown in FIG. 8B, wherein additional receiving structures 58, 58′, 58″ have been mounted to the attachment structures 56 (see FIG. 7B) of the transporting device 2 by means of pin members 62 inserted into the holes 60 (see FIG. 7B) provided in the attachment structures 56 (see FIG. 7B). The receiving structures 58, 58′, 58″ are shown in a closed configuration; however, they can be opened by pressing the attachment members 6, 6′ together.

FIG. 8D illustrates a perspective view of a segment of a transporting device 2 according to an embodiment of the invention. The transporting device 2 includes a centrally arranged attachment member 8 configured to receive engagement members (e.g. driving wheels) for driving the transporting device 2. The transporting device 2 furthermore includes wing members each provided with an attachment member 6, 6′. The transporting device 2 also includes an elongated attachment structure 56 extending along the length of the transporting device 2 and being provided with holes 60 for fixation of receiving structures.

FIG. 8E illustrates a perspective view of another segment of a transporting device 2 according to an embodiment of the invention. The transporting device 2 includes an attachment member 8 similar to the one shown in FIG. 7B, FIG. 7C and FIG. 7D. The transporting device 2 further includes wing members each provided with an attachment member 6, 6′. The transporting device 2 moreover includes a plurality of separated attachment structures 56, 56′, 56″ extending along the length of the transporting device 2 and being provided with holes 60 for fixation of receiving structures.

The transporting device 2 according to the invention may include one segment (a one-piece body) or two or more segments attached to each other.

### LIST OF REFERENCE NUMERALS

2 Transporting device
4 Wing member
6, 6′ Attachment member
8, 8′ Attachment member
10 Connection member
12, 12′ Side structure
14, 14′ End portion
16 Gap
18 Cavity
20 Space
22, 22′ Wheel
24, 24′ Wheel
26, 26′ Shaft
28, 28′ Motor
30 Canal
32 Gap
34 Attachment structure
36 Connection structure
38 Reinforcement structure
40 Item
42, 42′ Engagement structure (cavity)
44 Body
46 Transporting system
48 Motor
50, 50′, 50″, 50′″ Wheel
52 Idler
54, 54′, 54′ Segment
56, 56′, 56′ Attachment structure
58, 58′, 58′ Receiving structure
60 Hole
62 Pin member
X, Y, Z Axis

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

That which is claimed is:

1. A transporting device for conveying items over a conveying route, the transporting device comprising:
a first end portion, a second end portion, and a tubular flexible body having an interior space, wherein either a gap is provided between the first and second end portions or the first and second end portions are movable away from each other to form a gap between said first and second end portions;
wherein the tubular flexible body comprises a first side structure and a second side structure joined together and attached to the tubular flexible body at an area, each side structure having a free end;
wherein the first end portion is positioned at the free end of the first side structure, and the second end portion is positioned at the free end of the second side structure;
wherein the first end portion is directed towards and opposes the second end portion;
a first wing member and a second wing member protruding from said area, wherein the two wing members are displaceable towards each other to increase the size of said gap or to form said gap;
wherein the wing members are attached to the tubular flexible body in such a manner that displacement of the wing members causes said first and second end portions to be moved away from each other, whereby said gap is increased; and
wherein said interior space is arranged and configured to contain the items to be conveyed when using the transporting device, and wherein items can be inserted into and removed from the interior space when said gap is formed between the end portions.

2. A transporting device according to claim 1, wherein the tubular flexible body extends along a longitudinal direction and said gap extends longitudinally.

3. A transporting device according to claim 1, wherein the first and second side structures surround the interior space and together form a C-shaped or O-shaped cross section.

4. A transporting device according to claim 1, further comprising:
an attachment member at an end of each wing member opposite from said area.

5. A transporting device according to claim 3, further comprising:
a connection member including an attachment member at a distal end thereof, said connection member protruding from said area.

6. A transporting device according to claim 1, wherein said first and second end portions abut each other.

7. A transporting device according to claim 1, wherein:
the transporting device extends along a longitudinal length; and
the transporting device has a constant cross section along said length.

8. A transporting device according to claim 1, wherein the transporting device is transparent or comprises transparent structures.

9. A transporting device according to claim 3, wherein:
the interior space comprises a cavity extending along an inner side of the tubular flexible body along said area.

10. A transport system comprising:
a transporting device according to claim 1; and
one or more driving structures.

11. A transport system according to claim 10, wherein one of said one or more driving structures is a motor.

12. A transport system according to claim 10, wherein the one or more driving structures comprises an engagement structure having a rotatably mounted wheel.

13. A transport system according to claim 11, further comprising:
a rotatably mounted wheel mechanically connected to the transporting device and to the motor.

14. A transport system according to claim 10, further comprising:
structures for displacing the first and second wing members at one or more predefined positions.
